(19) United States
(12) Patent Application Publication
(10) Pub. No.: US 2025/0377928 A1
(43) Pub. Date: Dec. 11, 2025

(54) CHANGE MANAGEMENT FOR RESOURCES USED BY DATA PROCESSING SYSTEMS

(71) Applicant: Dell Products L.P., Round Rock, TX (US)

(72) Inventors: MAXIM BALIN, Gan-Yavne (IL); NECHAMI MAMAN, Jerusalem (IL); EYAL PORGES, Jerusalem (IL)

(21) Appl. No.: 18/735,731

(22) Filed: Jun. 6, 2024

(51) Int. Cl. G06F 9/48; G06F 9/50

(52) U.S. Cl. CPC G06F 9/485; G06F 9/5083; G06F 2209/485; G06F 2209/508

(57) ABSTRACT

Methods and systems for managing resources used by data processing systems to provide computer-implemented services are disclosed. An update event for a common resource used by a portion of the data processing systems may occur. Based on an identification of the update event, at least one resource registered as being dependent on the common resource (e.g., a dependent resource) may be identified. A change made to the common resource that may cause the dependent resource to be unable to operate with the common resource in a desired manner may be identified. To manage the change, an action set may be identified. The action set may include actions that, when performed, enable the desired operation after the change. Performance of the action set may be initiated to facilitate the provisioning of the computer-implemented services.

### FIELD

Embodiments disclosed herein relate generally to management of data processing systems. More particularly, embodiments disclosed herein relate to systems and methods to manage resources used by the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing resources used by data processing systems to provide computer-implemented services. The resources may include, for example, data repositories (e.g., databases), pieces of software (e.g., code), applications, hardware components, and/or other types of resources usable to facilitate the services provided by the data processing systems.

In order to provide the computer-implemented services, a portion of the data processing systems may use a distributed system of resources. For example, the portion of the data processing systems may use a combination of common resources managed by a first entity, and other resources managed by a second entity that may be dependent on the common resources (e.g., dependent resources). The common resources may be created and/or managed by a developer and may be offered as a service to stakeholders who may manage the dependent resources. Therefore, operation of the dependent resources and the common resources may be established (e.g., configured) in a manner that facilitates their cooperative operation to provide desired computer-implemented services.

Over time and for various reasons, new common resources may be added and/or existing common resources may be updated (e.g., by their managing entity), which may modify the manner in which the common resources operate. The modifications made to the common resources may adversely affect operation of associated dependent resources by virtue of their dependence on the prior manner of operation of the common resources. For example, if a service provided by a common resource is moved (e.g., a network address is changed), or if portions of a code base of the common resources are modified (e.g., changing identifiers or an output of an algorithm), then the dependent resources may no longer be able to operate in a manner that facilitates provision of the computer-implemented services.

In addition, to manage modifications made to the common resources, sets of coordinated actions may be required to be performed by each managing entity in the distributed system of resources. This may present delays (e.g., in communication between the managing entities, in performance of critical processes), and/or may introduce errors (e.g., in execution of the actions), which may prevent provision of the desired computer-implemented services.

To increase the likelihood of providing the desired computer-implemented services during changes to the common resources, a management framework may be implemented. The management framework may allow for automated performance of critical processes, improved communication and collaboration between the managing entities, and improved reliability in managing and executing the required actions. By doing so, response quality, response time, and overall adaptability to the modifications may be improved.

Thus, embodiments disclosed herein may address, among others, the technical problem of managing occurrences of update events (e.g., modifications) for common resources used by data processing systems of a distributed system. By implementing the management framework, the data processing systems may be more likely to provide the desired computer-implemented services.

In an embodiment, a method for managing resources used by data processing systems to provide computer-implemented services is provided. The method may include making an identification that an update event has occurred for a common resource used by at least a first portion of the data processing systems.

Based on the identification, the method may include: identifying a dependent resource that is registered as being dependent on the common resource, the dependent resource being used by at least a second portion of the data processing systems; identifying a change made to the common resource, the dependent resource being unable to operate with the common resource in a same manner as prior to the change due to the change; identifying an action set that, when performed, facilitates operation of the dependent resource with the common resource after the change; and, initiating performance of the action set to facilitate provisioning of the computer-implemented services by the data processing systems.

The action set may include: selecting an automated set of actions based on the change, the automated set of actions being performed without user intervention to update the operation of the dependent resource to reduce impacts on the operation of the dependent resource due to the change; and, using an automation framework to perform the automated set of actions.

The action set may also include: selecting, based on the change, a distributed workflow to manage the change to the common resource, the distributed workflow including tasks; assigning the tasks for performance; closing the tasks as confirmation of completion of each of the tasks is obtained; and, documenting the tasks and completion of each of the tasks.

Assigning the tasks for performance may include sending information regarding at least one of the tasks to a stakeholder that uses the dependent resource to effectuate a goal.

Closing the tasks may include monitoring communications from the stakeholder to identify a completion of the at least one of the tasks, and marking the at least one of the tasks as completed based on the monitoring of the communications.

A task of the task may require that the stakeholder modify operation of a data processing system of the second portion of the data processing systems to account for at least a portion of the change.

A task of the task may require that the stakeholder initiate modification of the operation the dependent resource to account for at least a portion of the change.

The action set may further include notifying all stakeholders of the update event to initiate use of an interface, by the stakeholders, through which progress information regarding completion of the distributed workflow is available.

The method may further include, prior to making the identification: obtaining a first registration request for the common resource, the first registration request indicating creation of the common resource; and, registering the common resource based on the first registration request.

The method may further include, prior to making the identification and after obtaining the first registration request: obtaining a second registration request for the dependent resource, the second registration request indicating a manner in which the dependent resource is dependent upon the common resource; and, registering the dependent resource with respect to the common resource based on the second registration request.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

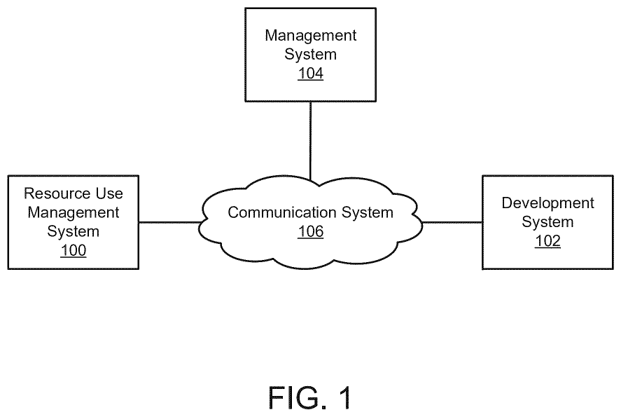

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, and/or any other type of service that may be implemented with a computing device.

To provide the computer-implemented services, any number of data processing systems may use resources such as portions of software, hardware, and/or data. The data processing systems may provide the computer-implemented services (cooperatively or independently) using various combinations of the resources. The resources may include common resources (e.g., a same resource used by different data processing systems of the distributed system) and/or dependent resources (e.g., resources that are dependent on and/or operate in cooperation with a common resource). The common resources and the dependent resources may be managed by separate entities, and provision of the computer-implemented services may depend on cooperative operation of the resources.

Over time, modifications (e.g., updates, changes) may be made to the common resources (e.g., by their managing entity) in order to add functionality, address security issues and/or to make improvements (e.g., to quality, speed and/or other aspects) of the provided computer-implemented services. The modifications made to the common resources may affect operation of the dependent resources by virtue of their dependence. For example, some modifications made to the common resources may prevent the dependent resources from performing operations necessary for providing the desired computer-implemented services.

In order to facilitate provision of the desired computer-implemented services after a modification of common resources, a set of actions may be required to be performed by a managing entity of the dependent resources before the modification occurs. For example, actions of the set of actions may relate to updating the operation of the dependent resources, adding new (dependent) resources, changing configuration settings associated with existing (dependent) resources, and/or updating operation of a portion of data processing systems that host the dependent resources. However, the set of actions may include large numbers of tasks that may be required to be performed in sequence and coordination by different managing entities, which may lead to issues in communication, coordination, and completion of the tasks or actions without error.

In general, embodiments disclosed herein may provide methods, systems, and/or devices for managing modifications (e.g., changes) to resources used by data processing systems in a manner that may increase the likelihood of the data processing systems providing the computer-implemented services throughout the change process. To manage the modifications, a management framework may be implemented. The management framework may include tools and processes for identifying and responding to update events for (e.g., changes to) the common resources in a manner that improves communication and coordination of tasks across multiple managing entities.

By doing so, embodiments disclosed herein may provide for improved resource management in view of changes to common resources, and an increased likelihood of continued provision of desired computer-implemented services after the changes are implemented.

To provide the above noted functionality, the system of FIG. 1 may include resource use management system 100, development system 102, management system 104, and communication system 106. Each of these components is discussed below.

To obtain common resources that may be used by data processing systems (not shown), the system may include development system 102. Development system 102 may include data processing systems or other devices operated by an entity such as a developer. Development system 102 may be used (e.g., by the developer) to create resources such as common resources, and/or to make modifications to existing resources (e.g., the common resources). Development system 102 may facilitate use of the common resources by other systems that may be managed by a different entity, such as resource use management system 100.

Resource use management system 100 may manage use of resources by the data processing systems in order to provide computer-implemented services. Resource use management system 100 may include data processing systems or other devices managed by an entity different than that of development system 102. For example, resource use management system 100 may be managed by a stakeholder, and resource use management system 100 may be used by the stakeholder to identify whether resources used in providing the computer-implemented services are dependent on any common resources of development system 102.

Resource use management system 100 may include and/or be associated with a deployment operated by a system administrator tasked with managing the deployment. For example, the system administrator may manage pieces of software and/or manage configuration settings for the deployment to facilitate cooperative operation of dependent resources and common resources. Resource use management system 100 may identify resource dependencies and/or additional requirements for using resources created and/or updated by development system 102.

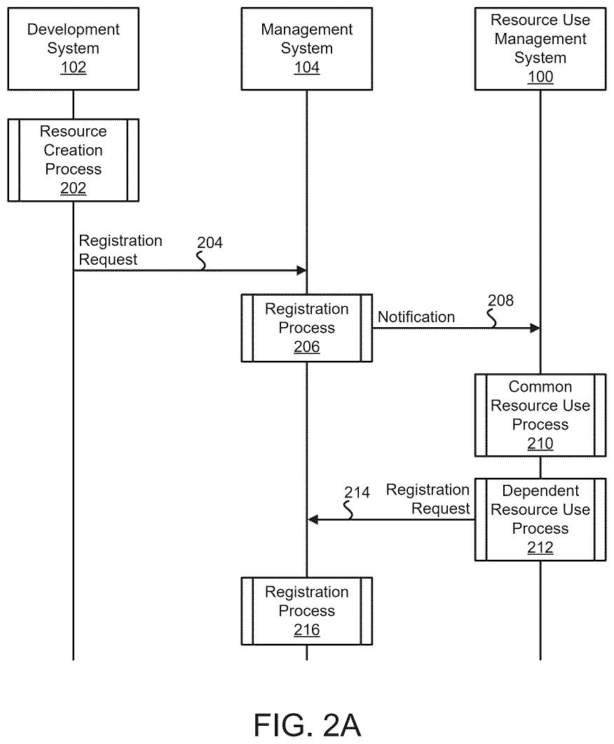

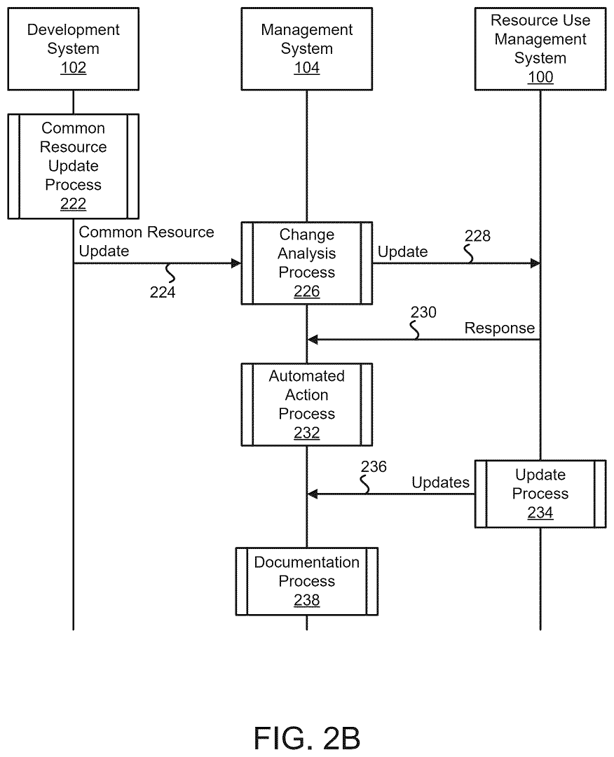

To manage modifications to the common resources, common resources and associated dependent resources may be registered with management system 104. To do so, development system 102 may register common resources at the time of their creation, and resource use management system 100 may report identified dependencies and/or requirements to management system 104. By doing so, management system 104 may be equipped to respond to future modifications made to the common resources. Refer to the discussion of FIG. 2A for more information regarding resource registration processes.

To provide its functionality, management system 104 may (i) perform registration processes for common resources and associated dependent resources, (ii) identify occurrences of update events (e.g., planned modifications for) the registered common resources, (iii) perform change analysis processes to identify changes made to common resources that may prevent desired operation of one or more associated dependent resources, (iv) identify actions that, when performed, facilitate the desired operation of the one or more dependent resources after the changes are made to the common resources, (v) initiate automated actions (e.g., of the identified actions) that may update operation of common and/or dependent resources, (vi) facilitate communication between various managing entities (e.g., of the common resources, of the dependent resources) to allow for efficient coordination of actions, and/or (vii) perform other actions relating to management of resources used by data processing systems (e.g., documentation processes to identify potential issues with managing the changes and/or root causes of any identified issues).

For example, management system 104 may manage planned changes to common resources by development system 102. The changes may be managed in a manner that facilitates provision of desired computer-implemented services after the changes are implemented (e.g., using the changed common resources) by identifying and initiating corresponding actions/tasks relating to associated dependent resources and/or systems thereof. Refer to the discussion of FIG. 2B for more information regarding management of updates to common resources.

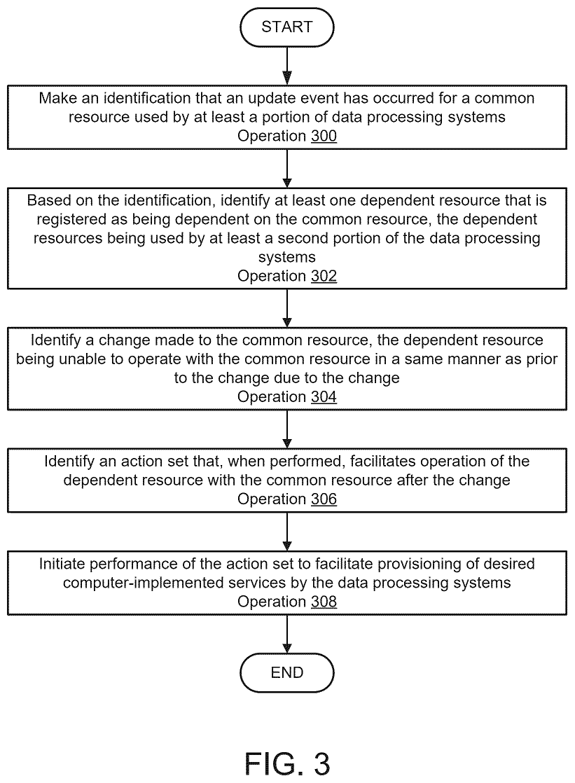

When providing their functionality, any of (and/or components thereof) resource use management system 100, development system 102, and/or management system 104 may perform all, or a portion, of the actions and methods illustrated in FIGS. 2A-3.

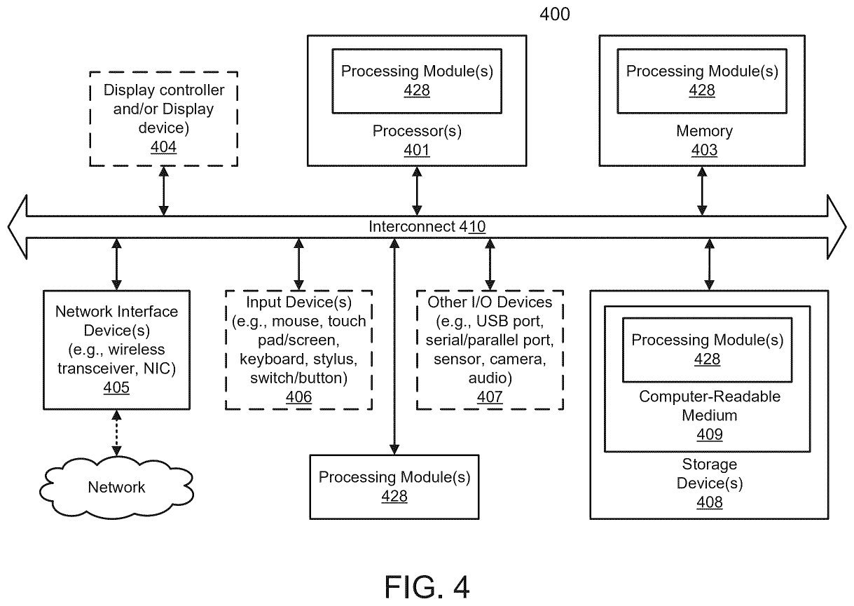

Any of (and/or components thereof) resource use management system 100, development system 102, and management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, interaction diagrams in accordance with an embodiment are shown in FIGS. 2A-2B. These interaction diagrams may illustrate how data may be obtained and used within the system of FIG. 1.

In the interaction diagrams, processes performed by and interactions between components of a system in accordance with an embodiment are shown. In the diagrams, components of the system are illustrated using a first set of shapes (e.g., 100, 102, etc.), located towards the top of each figure. Lines descend from these shapes. Processes performed by the components of the system are illustrated using a second set of shapes (e.g., 202, 206, etc.) superimposed over these lines. Interactions (e.g., communication, data transmissions, etc.) between the components of the system are illustrated using a third set of shapes (e.g., 204, 208, etc.) that extend between the lines.

Generally, the processes and interactions are temporally ordered in an example order, with time increasing from the top to the bottom of each page. For example, the interaction labeled as 204 may occur prior to the interaction labeled as 208. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during registering of resources with a management system.

Before registering the resources, development system 102 may be used to obtain a resource. To do so, development system 102 may perform resource creation process 202. During resource creation process 202, development system 102 may be used, for example, by developers, to generate (e.g., create) a common resource. The common resource may include a piece of software, a portion of code, and/or any other type of data structure (e.g., a database, a data repository), and may be offered as a service to other entities (e.g., stakeholders). Once created, the common resource may undergo testing and/or validation processes before being made available for use by, for example, a third-party deployment of data processing systems operated by a stakeholder.

To register the common resource, development system 102 may obtain a registration request. For example, a registration request for the common resource may be generated by development system 102 automatically (e.g., based on an outcome of a testing, validation and/or approval process). The registration request for the common resource may be a data structure that includes information regarding the common resource (e.g., information regarding its functionality, version identifiers). For example, the registration request for the common resource may include version information of the common resource, information regarding development system 102, information regarding responsible entities (e.g., subject matter experts, developers), cryptographic information (e.g., for authentication between systems and/or entities), etc.

At interaction 204, the registration request (for the common resource) may be provided to management system 104 by development system 102. For example, the registration request may be generated and provided to management system 104 via (i) transmission via a message, (ii) storing in a storage with subsequent retrieval by management system 104, (iii) a publish-subscribe system where management system 104 subscribes to updates from development system 102 thereby causing a copy of the registration request to be propagated to management system 104, and/or (iv) other processes. By providing the registration request to management system 104, management system 104 may initiate a registration process for the common resource.

Registration process 206 may be performed by management system 104 upon obtaining the registration request. For example, management system 104 may obtain, validate, and/or read the registration request before initiating registration process 206. The registration request may indicate that the common resource has been created and/or is approved for registration. During registration process 206, management system 104 may store information regarding the common resource (e.g., information included in the registration request), and/or other information (e.g., date of registration). During registration process 206, management system 104 may communicate with development system 102 to notify development system 102 of successful (or unsuccessful) registration (not shown).

During registration process 206, upon successful registration of the common resource, management system 104 may notify resource use management system 100 of the creation and/or availability of the common resource. For example, resource use management system 100 (and/or users thereof) may be registered with management system 104 as a potential user of common resources (e.g., previously registered via another system and/or management system 104). A notification regarding the common resource may be obtained and/or provided to resource use management system 100 as part of registration process 206. Other potential users of the common resource may also be notified.

At interaction 208, the notification may be provided to resource use management system 100 by management system 104. For example, the notification may be generated and provided to resource use management system 100 via (i) transmission via a message, (ii) storing in a storage with subsequent retrieval by resource use management system 100, (iii) a publish-subscribe system where resource use management system 100 subscribes to updates from management system 104 thereby causing a copy of the notification to be propagated to resource use management system 100, and/or (iv) other processes. The notification may request information regarding resource dependencies associated with the common resource.

While described with respect to an active step of notification, it will be appreciated that management system 104 may passively notify other entities of the common resource. For example, management system 104 may add information regarding the common resource to a catalog, which may be reviewed by resource use management system 100 and/or other entities over time. Thus, upon obtaining the notification, resource use management system 100 may be prompted to analyze resource dependencies with respect to the common resource.

To analyze resource dependencies, resource use management system 100 may perform common resource use process 210. During common resource use process 210, a managing entity of resource use management system 100 may obtain, install, and/or use (e.g., execute) the common resource. Use of the common resource may initiate use of other resources that may depend on the common resource. For example, during common resource use process 210, resource use management system 100 may be prompted to initiate dependent resource use process 212.

During dependent resource use process 212, the managing entity of resource use management system 100 may adjust configuration settings and/or install additional software in order to facilitate provision of desired computer-implemented services using the common resource. For example, resources that are added, updated and/or executed during dependent resource use process 212 may be considered dependent resources associated with the common resource. A data structure listing these dependencies (e.g., dependent resources) may be obtained (e.g., generated) during dependent resource use process 212.

The list of dependencies may be included as part of a registration request for the dependent resource(s). For example, the registration request for the dependent resource(s) may be a data structure that includes information regarding resource use management system 100, details of the dependencies (e.g., manners in which the dependent resources are dependent on the common resource), cryptographic information (e.g., for authentication between systems and/or entities), etc. The registration request for the dependent resource(s) may be provided to management system 104 automatically as part of dependent resource use process 212.

At interaction 214, the registration request (for the dependent resource(s)) may be provided to management system 104 by resource use management system 100. For example, the registration request may be generated and provided to management system 104 via (i) transmission via a message, (ii) storing in a storage with subsequent retrieval by management system 104, (iii) a publish-subscribe system where management system 104 subscribes to updates from resource use management system 100 thereby causing a copy of the registration request to be propagated to management system 104, and/or (iv) other processes. By providing the registration request to management system 104, management system 104 may initiate a registration process for the dependent resource(s).

Upon obtaining the registration request for the dependent resource(s) from resource use management system 100, management system 104 may read and/or validate the registration request. The registration request may indicate that an entity using the common resource has dependent resources associated with the common resource; therefore, once validated, management system 104 may perform registration process 216 to register the dependent resource(s) as being dependent on the common resource.

During registration process 216, management system 104 may store information regarding the dependent resources and their associations to the common resource. During registration process 216, management system 104 may communicate with resource use management system 100 to notify resource use management system 100 of successful (or unsuccessful) registration of the dependent resources (not shown). For example, management system 104 may update information displayed via an interface used by entities of resource use management system 100 (e.g., hosted by management system 104) to indicate that the dependencies have been registered with the common resource.

Management system 104 may obtain any number of registration requests (for dependent resources) from any number of entities, (e.g., stakeholders, operators of deployments that may use the common resource), and may perform registration processes for each registration request accordingly.

Thus, as shown in the example in FIG. 2A, resources used in providing computer-implemented services and their dependencies may be registered with a management system. Once registered, changes made to common resources may be managed in a manner that increases the likelihood of associated dependent resources operating in a desired manner throughout the change process.

Turning to FIG. 2B, a second interaction diagram in accordance with an embodiment is shown. The second interaction diagram may illustrate processes and interactions that may occur during management of updates (e.g., changes) to common resources used by data processing systems to provide computer-implemented services.

Over time, update events for the common resources may occur. For example, developers of the common resources may wish to update (e.g., make modifications to) a common resource in order to improve aspects of its use and/or performance. To do so, development system 102 may perform common resource update process 222. During common resource update process 222, modifications to a common resource may be identified and/or implemented (e.g., by developers using development system 102). For example, portions of code may be modified, added, or removed, and/or configuration settings required for desired use of the common resource may change (e.g., a new version of the common resource may be obtained).

The modifications to the common resource may impact operation of other resources that provide the computer-implemented services cooperatively with the common resource. For example, the common resources may be used by data processing systems of a deployment operated by a stakeholder. To notify the stakeholder of the update event, information regarding the update event may be obtained during common resource update process 222. The information regarding the update may include, for example, identifying information for the common resource, information outlining the update (e.g., details of the modifications), information regarding the release of the updated common resource (e.g., a timeline) and/or other information (e.g., priority level or impact level of the update).

Upon completion of common resource update process 222, development system 102 may notify management system 104 of the update to the common resource by obtaining (e.g., generating) a common resource update. The common resource update may be a data structure that includes the information regarding the update and/or other information.

At interaction 224, the common resource update may be provided to management system 104 by development system 102 using methods similar to those described with respect to interaction 204 of FIG. 2A and/or via other methods. By providing the common resource update to management system 104, management system 104 may identify that an update event has occurred for the common resource, and may provide change management services.

To provide the services, management system 104 may perform change analysis process 226. During change analysis process 226, (i) a resource dependent on the common resource may be identified, (ii) a change made to the common resource that may prevent desired operation of the dependent resource with the updated common resource may be identified, and (iii) an action set that facilitates the desired operation of the dependent resource with the updated common resource may be identified.

To identify the dependent resource, previously defined dependencies between common resources and dependent resources may be analyzed. For example, management system 104 may identify a dependent resource that is registered as being dependent on the common resource (refer to the discussion of FIG. 2A regarding registration of resources with management system 104). Management system 104 may also identify a stakeholder associated with the dependent resource (e.g., for communication purposes).

Based on information obtained at the time of registration of the common resource and/or changes outlined in the common resource update, management system 104 may identify the change and a dependent resource that may be impacted by the change and/or a manner in which the dependent resource may be impacted.

The identified action set may be based on the identified changes and/or manners of impact of the changes. The action set may include tasks of a distributed workflow for managing the change to the common resource. For example, portions of the tasks may be assigned for performance by different entities (e.g., stakeholders, developers) of a distributed system. The action set may include actions that, when at least one of the actions is performed, improves the likelihood of the dependent resource operating in a desired manner after the change is made to the common resource.

During change analysis process 226, management system 104 may notify relevant stakeholders (e.g., those associated with the identified dependent resources) of the update event (e.g., the change) via email, messaging, project management tools, etc. For example, the notification may notify the stakeholders to initiate use of an interface (e.g., hosted by management system 104) through which progress information regarding completion of the distributed workflow is available. For example, the interface may be used to manage (e.g., track, monitor, and/or communicate regarding) changes to common resources by both the stakeholders and management system 104.

At interaction 228, the update (e.g., notification of the change) may be provided by management system 104 to resource use management system 100, using methods similar to those described with respect to interaction 208 of FIG. 2A and/or via other methods. By providing the update to resource use management system 100, for example, resource use management system 100 and/or a management entity thereof (e.g., an administrator) may respond to the reported change. For example, the stakeholder associated with the dependent resource may use the interface to view details of the change, including its level of impact, timeline for implementation, and/or the required actions (e.g., of the action set) to manage the change.

The stakeholder may provide a response to the update. For example, the response may include acknowledgement of, acceptance of, rejection of, and/or feedback regarding the update and/or any associated actions. In other words, the response may indicate a confirmation of understanding of the update, impacts of the update, and/or a commitment to perform the required actions (e.g., tasks) within a period of time. The response may include associations between required actions and entities (e.g., individuals) accountable for performance and completion of the actions. In other words, actions of the action set may be assigned to various entities for performance, which may be reflected in the response.

At interaction 230, the response may be provided to management system 104 by resource use management system 100. For example, the response may be provided via the interface and/or using methods similar to those described with respect to interaction 214 of FIG. 2A. By providing the response to management system 104, management system 104 may monitor and track task completion, and/or otherwise manage the change process for the common resource. For example, management system 104 may initiate and/or perform automated actions throughout the change process.

To do so, management system 104 may perform automated action process 232. During automated action process 232, some actions of the action set may include automated actions. For example, the automated actions may be performed without user intervention, and may update operation of the dependent resource (or other resources). The automated actions may be initiated and/or performed by development system 102, resource use management system 100, and/or another entity using an automation framework. For example, based on the change, the automation framework may automatically update (e.g., modify and recompile) a codebase associated with the dependent resource, automatically update configuration settings, and/or automatically trigger specific processes.

To manage performance of the required actions, resource use management system 100 may perform update process 234. During update process 234, tasks associated with the required actions may be performed. For example, a task of the tasks may require the stakeholder to modify operation of a data processing system of the deployment that uses the dependent resource and the common resource to provide computer-implemented services in order to account for a portion of the change to the common resource. Or, for example, a task of the tasks may require the stakeholder to modify operation of the dependent resource to account for a portion of the change to the common resource. As tasks are completed, management system 104 may be updated accordingly (e.g., in real-time) to reflect confirmation of task completion via updates from resource use management system 100.

At interaction 236, the updates may be provided to management system 104 by resource use management system 100 using methods similar to those described with respect to interaction 214 of FIG. 2A and/or by other methods. For example, the stakeholder may provide updates via the interface as tasks are initiated and completed. Based on the updates, management system 104 may identify real-time progression through the tasks, which may improve transparency and accountability throughout the process. By improving transparency and accountability, bottlenecks and/or other issues encountered during the change process may be identified in real-time, which may reduce delays and/or errors in completion of the change process.

Management system 104 may monitor communications (e.g., updates) from resource use management system 100 (e.g., the stakeholder) to document completion of each of the tasks. Completed tasks may be closed (e.g., marked as completed) based on the monitored communications. As portions of the tasks are closed (e.g., as progress milestones are met), management system 104 may notify development system 102 and/or other entities regarding the task progress (not shown). Development system 102 may release new versions of common resources for use by stakeholders based on the task progress.

To improve the change process (e.g., portions of the distributed workflow), management system 104 may perform documentation process 238. During documentation process 238, management system 104 may (i) record and track activities (e.g., of any entity participating in the change process), (ii) perform quality checks, (iii) perform security validations, (iv) use feedback obtained from stakeholders to improve the change process, and/or (v) perform other auditing actions in order to ensure compliance with the required actions. For example, during documentation process 238, root cause analysis reports may be generated to investigate incidents, errors, lack of compliance, etc. The root cause analysis reports may be used, for example, to improve bug fixes and/or correct misconfigurations.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, by processes and interactions shown in FIGS. 2A-2B, changes to common resources used by data processing systems to provide computer-implemented services may be managed in a manner that improves communication and coordination, and reduces manual intervention, the likelihood of downtime, and the risk of errors during the change process. In addition, the system and methods described with respect to FIGS. 1-2B may be integrated with existing software systems, which may facilitate data exchange and enhance overall efficiency and experience of the change process.

As discussed above, the components of FIG. 1 may perform various methods to improve management of update events for resources used by data processing systems when providing computer-implemented services. FIG. 3 illustrates a method that may be performed by the components of the system of FIG. 1 and/or by other components. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing resources used by data processing systems to provide computer-implemented services in accordance with an embodiment is shown.

Prior to operation 300, the resources may be registered with a management system. The resources may be registered using methods described with respect to FIG. 2A and/or by other methods. For example, a common resource used by at least a first portion of the data processing systems may be registered by (i) obtaining a first registration request for the common resource (e.g., indicating creation of the common resource), and/or (ii) registering the common resource based on the first registration request. For example, information regarding the common resource may be stored in a registration database.

After obtaining the first registration request, a dependent resource may be registered by (i) obtaining a second registration request for the dependent resource (e.g., indicating a manner in which the dependent resource is dependent upon the common resource), and/or (ii) registering the dependent resource with respect to the common resource based on the second registration request. For example, information regarding the dependent resource may be stored in a registration database in association with the common resource.

At operation 300, an identification that an update event has occurred for the common resource may be made. The identification may be made by obtaining a notification regarding a common resource update (e.g., from a developer system that manages the common resource or another entity), and/or via other methods. The update event may include a modification made to the common resource that may affect operation and/or functionality of other resources (e.g., associated dependent resources).

At operation 302, based on the identification, a dependent resource that is registered as being dependent on the common resource may be identified. The dependent resource may be identified by (i) obtaining notice of the dependent resource (e.g., from a third party), (ii) querying the registration database using information regarding the common resource, and selecting the dependent resource that is associated with the common resource in the registration database, and/or (iii) by other methods. The dependent resources may be used by at least a second portion of the data processing systems to provide the computer-implemented services.

At operation 304, a change made to the common resource may be identified. The change may be identified by (i) obtaining a notice of the change (e.g., from a third party), and/or (ii) performing a change analysis process (e.g., change analysis process 226 of FIG. 2B). The change may include a change that causes the dependent resource to be unable to operate with the common resource in a same manner as prior to the change being made to the common resource.

At operation 306, an action set that, when performed, facilitates operation of the dependent resource with the common resource after the change may be identified. The action set may be identified by (i) obtaining the action set (e.g., from another entity), and/or (ii) generating the action set. For example, a portion of the action set may be generated by analyzing the change made the common resource and identifying a relationship usable to map characteristics of the common resource before the change to characteristics of the changed common resource.

The action set may include automated actions. For example, the action set may include (i) selecting an automated set of actions based on the change, and (ii) using an automation framework to perform the automated set of actions. For example, the automated set of actions may be selected from a list of automated actions that are associate with the change. Using the automation framework to perform the automated set of actions may include sending instructions to systems participating in a distributed workflow that manages the change to the common resource. The automated set of actions may be performed without user intervention to update the operation of the dependent resource to reduce impacts on the operation of the dependent resource due to the change.

The action set (e.g., the automated actions) may include notifying all stakeholders of the update event to initiate use of an interface, by the stakeholders, through which progress information regarding completion of the distributed workflow is available. Notifying the stakeholders via the interface may include transmitting a message via any means of communication (e.g., email, messaging, software such as project management tools) and/or causing a pop-up notification regarding the update event via the interface.

The action set may also include (i) selecting, based on the change, tasks of a distributed workflow to manage the change to the common resource, (ii) assigning the tasks for performance, (iii) closing the tasks as confirmation of completion of each of the tasks is obtained, and/or (iv) documenting the tasks and completion of each of the tasks. For example, the distributed workflow may be selected by identifying the tasks that are associated with the change.

Assigning the tasks for performance may include sending information regarding at least one of the tasks to a stakeholder that uses the dependent resource to effectuate a goal. The information may be sent via any means of communication, including via the interface.

Closing the tasks may include (i) monitoring communications from the stakeholder to identify a completion of the at least one of the tasks and/or (ii) marking the at least one of the tasks as completed based on the monitoring of the communications. For example, the communications may be monitored and closed based on stakeholder input to the interface.

At operation 308, performance of the action set may be initiated. Performance of the action set may be initiated by (i) providing instructions for performing the automated actions to systems participating in the distributed workflow, (ii) notifying entities participating in the distributed workflow (and/or that may otherwise be affected by the change to the common resource) of the required actions, and/or (iii) executing instructions for performing actions of the action set.

Performance of the action set may facilitate provisioning of the computer-implemented services by the data processing systems (e.g., after the change is made to the common resource). For example, performance of the action set may include code updates that modify operation of the dependent resource to account for at least a portion of the change, and/or may include configuration setting updates that modify operation of a data processing system of the second portion of the data processing systems to account for at least a portion of the change.

After performance of the action set is complete and the change to the common resources is made, the computer-implemented services may be provided by the data processing systems by executing instructions, portions of which may be executed using the common resource and/or the dependent resources.

The method may end following operation 308.

Thus, using the method shown in FIG. 3, embodiments disclosed herein may manage the effects of changes made to common resources on associated dependent resources in a manner that improves the likelihood of providing desired computer-implemented services after the changes are made.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing resources used by data processing systems to provide computer-implemented services, the method comprising:
making an identification that an update event has occurred for a common resource used by at least a first portion of the data processing systems; and
based on the identification:
identifying a dependent resource that is registered as being dependent on the common resource, the dependent resource being used by at least a second portion of the data processing systems,
identifying a change made to the common resource, the dependent resource being unable to operate with the common resource in a same manner as prior to the change due to the change,
identifying an action set that, when performed, facilitates operation of the dependent resource with the common resource after the change, and
initiating performance of the action set to facilitate provisioning of the computer-implemented services by the data processing systems.

2. The method of claim 1, wherein the action set comprises:
selecting an automated set of actions based on the change, the automated set of actions being performed without user intervention to update the operation of the dependent resource to reduce impacts on the operation of the dependent resource due to the change; and
using an automation framework to perform the automated set of actions.

3. The method of claim 1, wherein the action set comprises:
selecting, based on the change, a distributed workflow to manage the change to the common resource, the distributed workflow comprising tasks;
assigning the tasks for performance;
closing the tasks as confirmation of completion of each of the tasks is obtained; and
documenting the tasks and completion of each of the tasks.

4. The method of claim 3, wherein assigning the tasks for performance comprises:
sending information regarding at least one of the tasks to a stakeholder that uses the dependent resource to effectuate a goal.

5. The method of claim 4, wherein closing the tasks comprises:
monitoring communications from the stakeholder to identify a completion of the at least one of the tasks; and
marking the at least one of the tasks as completed based on the monitoring of the communications.

6. The method of claim 4, wherein a task of the task requires that the stakeholder modify operation of a data processing system of the second portion of the data processing systems to account for at least a portion of the change.

7. The method of claim 4, wherein a task of the task requires that the stakeholder initiate modification of the operation the dependent resource to account for at least a portion of the change.

8. The method of claim 3, wherein the action set further comprises:
notifying all stakeholders of the update event to initiate use of an interface, by the stakeholders, through which progress information regarding completion of the distributed workflow is available.

9. The method of claim 1, further comprising:
prior to making the identification:
obtaining a first registration request for the common resource, the first registration request indicating creation of the common resource; and
registering the common resource based on the first registration request.

10. The method of claim 9, further comprising:
prior to making the identification and after obtaining the first registration request:
obtaining a second registration request for the dependent resource, the second registration request indicating a manner in which the dependent resource is dependent upon the common resource; and
registering the dependent resource with respect to the common resource based on the second registration request.

11. A non-transitory machine-readable medium having instructions stored therein, which when executed by a processor, cause the processor to perform operations for managing resources used by data processing systems to provide computer-implemented services, the operations comprising:
making an identification that an update event has occurred for a common resource used by at least a first portion of the data processing systems; and
based on the identification:
identifying a dependent resource that is registered as being dependent on the common resource, the dependent resource being used by at least a second portion of the data processing systems,
identifying a change made to the common resource, the dependent resource being unable to operate with the common resource in a same manner as prior to the change due to the change,
identifying an action set that, when performed, facilitates operation of the dependent resource with the common resource after the change, and
initiating performance of the action set to facilitate provisioning of the computer-implemented services by the data processing systems.

12. The non-transitory machine-readable medium of claim 11, wherein the action set comprises:
selecting an automated set of actions based on the change, the automated set of actions being performed without user intervention to update the operation of the dependent resource to reduce impacts on the operation of the dependent resource due to the change; and
using an automation framework to perform the automated set of actions.

13. The non-transitory machine-readable medium of claim 11, wherein the action set comprises:
selecting, based on the change, a distributed workflow to manage the change to the common resource, the distributed workflow comprising tasks;
assigning the tasks for performance;
closing the tasks as confirmation of completion of each of the tasks is obtained; and
documenting the tasks and completion of each of the tasks.

14. The non-transitory machine-readable medium of claim 13, wherein assigning the tasks for performance comprises:
sending information regarding at least one of the tasks to a stakeholder that uses the dependent resource to effectuate a goal.

15. The non-transitory machine-readable medium of claim 14, wherein closing the tasks comprises:
monitoring communications from the stakeholder to identify a completion of the at least one of the tasks; and
marking the at least one of the tasks as completed based on the monitoring of the communications.

16. A system, comprising:
a processor; and
a memory coupled to the processor to store instructions, which when executed by the processor, cause operations for managing resources used by data processing systems that provide computer-implemented services to be performed, the operations comprising:
making an identification that an update event has occurred for a common resource used by at least a first portion of the data processing systems, and
based on the identification:
identifying a dependent resource that is registered as being dependent on the common resource, the dependent resource being used by at least a second portion of the data processing systems;
identifying a change made to the common resource, the dependent resource being unable to operate with the common resource in a same manner as prior to the change due to the change;
identifying an action set that, when performed, facilitates operation of the dependent resource with the common resource after the change; and
initiating performance of the action set to facilitate provisioning of the computer-implemented services by the data processing systems.

17. The system of claim 16, wherein the action set comprises:
selecting an automated set of actions based on the change, the automated set of actions being performed without user intervention to update the operation of the dependent resource to reduce impacts on the operation of the dependent resource due to the change; and
using an automation framework to perform the automated set of actions.

18. The system of claim 16, wherein the action set comprises:
selecting, based on the change, a distributed workflow to manage the change to the common resource, the distributed workflow comprising tasks;
assigning the tasks for performance;
closing the tasks as confirmation of completion of each of the tasks is obtained; and
documenting the tasks and completion of each of the tasks.

19. The system of claim 18, wherein assigning the tasks for performance comprises:
sending information regarding at least one of the tasks to a stakeholder that uses the dependent resource to effectuate a goal.

20. The system of claim 19, wherein closing the tasks comprises:
monitoring communications from the stakeholder to identify a completion of the at least one of the tasks; and
marking the at least one of the tasks as completed based on the monitoring of the communications.
